(19) United States
(12) Patent Application Publication
(10) Pub. No.: US 2026/0104266 A1
(43) Pub. Date: Apr. 16, 2026

(54) HEAD-MOUNTED DISPLAY AND METHOD FOR PATH PLANNING

(71) Applicant: HTC Corporation, Taoyuan City (TW)

(72) Inventor: Yu-Tzu Wang, Taoyuan City (TW)

(73) Assignee: HTC Corporation, Taoyuan City (TW)

(21) Appl. No.: 18/916,757

(22) Filed: Oct. 16, 2024

(51) Int. Cl. G01C 21/36; G06T 11/00

(52) U.S. Cl. CPC G01C 21/3676; G06T 11/00; G06T 2210/56

(57) ABSTRACT

A head-mounted device and a method for path planning are disclosed. The method includes: obtaining a layout diagram, a point cloud map, and a historical waypoint; obtaining a current point cloud through a sensor and comparing the current point cloud with the point cloud map to generate a current waypoint; and generating a virtual path between the current waypoint and the historical waypoint according to the layout diagram and the point cloud map, and outputting the virtual path.

### BACKGROUND

### Technical Field

This disclosure relates to an extended reality (XR) technology, and in particular to a head-mounted display and method for path planning.

### Description of Related Art

The XR system has been used in a variety of applications such as indoor navigation, where the head-mounted display (HMD) of the XR system displays information about the location of the user. For example, when a maintenance crew of an aircraft walks to a specific location in the cabin, the HMD can display information relevant to that specific location to the maintenance crew. However, the XR system takes a while to localize when it is activated. If a user of the XR System is unable to complete all work in the field in a short period of time, the XR System may need to be repositioned when the user returns to the field and activates the XR System to complete the remaining work. This results in a waste of the time of the user.

### SUMMARY

The disclosure provides a head-mounted device and a method for path planning, capable of automatically directing a user to a location where the user finished a previous work.

The head-mounted device for path planning of the disclosure includes a sensor, a storage medium, and a processor. The storage medium stores a layout diagram, a point cloud map, and a historical waypoint of a field. The processor is coupled to the sensor and the storage medium. The processor obtains a current point cloud through the sensor, and compares the current point cloud with the point cloud map to generate a current waypoint. The processor generates a virtual path between the current waypoint and the historical waypoint according to the layout diagram and the point cloud map, and outputs the virtual path.

In an embodiment of the disclosure, the processor generates the virtual path according to a first obstacle in the layout diagram and a second obstacle in the point cloud map.

In an embodiment of the disclosure, the processor generates the virtual path according to a third obstacle in the current point cloud.

In an embodiment of the disclosure, the processor obtains a first reference point corresponding to the layout diagram and a second reference point corresponding to the point cloud map. The processor aligns the layout diagram and the point cloud map according to the first reference point and the second reference point to generate a superimposed map. The processor generates the virtual path according to the superimposed map.

In an embodiment of the disclosure, the superimposed map indicates a first obstacle corresponding to the layout diagram and a second obstacle corresponding to the point cloud map.

In an embodiment of the disclosure, the processor executes a path planning algorithm based on the superimposed map to generate the virtual path.

In an embodiment of the disclosure, the path planning algorithm includes a dynamic window approach.

In an embodiment of the disclosure, the head-mounted device further includes an inertial measurement unit. The inertial measurement unit is coupled to the processor. The processor stores work progress and a corresponding waypoint in the storage medium according to a measurement result of the inertial measurement unit.

In an embodiment of the disclosure, the storage medium further stores historical work progress corresponding to the historical waypoint. In response to the head-mounted device reaching the historical waypoint, the processor configures a virtual scene outputted by the head-mounted device according to the historical work progress.

In an embodiment of the disclosure, the sensor includes at least one of the following: radar, lidar, and image capture device.

In an embodiment of the disclosure, the layout diagram includes a computer aided design diagram.

The method for path planning of the disclosure, adapted to a head-mounted device, includes the following. A layout diagram, a point cloud map, and a historical waypoint of a field are obtained. A current point cloud is obtained through a sensor, and the current point cloud is compared with the point cloud map to generate a current waypoint. A virtual path between the current waypoint and the historical waypoint is generated according to the layout diagram and the point cloud map, and the virtual path is outputted.

In an embodiment of the disclosure, generating the virtual path between the current waypoint and the historical waypoint according to the layout diagram and the point cloud map includes that the virtual path is generated according to a first obstacle in the layout diagram and a second obstacle in the point cloud map.

In an embodiment of the disclosure, generating the virtual path according to the first obstacle in the layout diagram and the second obstacle in the point cloud map includes that the virtual path is generated according to a third obstacle in the current point cloud.

In an embodiment of the disclosure, generating the virtual path between the current waypoint and the historical waypoint according to the layout diagram and the point cloud map includes the following. A first reference point corresponding to the layout diagram and a second reference point corresponding to the point cloud map is obtained. The layout diagram and the point cloud map are aligned according to the first reference point and the second reference point to generate a superimposed map. The virtual path is generated according to the superimposed map.

In an embodiment of the disclosure, the superimposed map indicates a first obstacle corresponding to the layout diagram and a second obstacle corresponding to the point cloud map.

In an embodiment of the disclosure, generating the virtual path according to the superimposed map includes that a path planning algorithm is executed according to the superimposed map to generate the virtual path.

In an embodiment of the disclosure, the path planning algorithm includes a dynamic window approach.

In an embodiment of the disclosure, the method further includes that work progress and a corresponding waypoint is stored according to a measurement result of the inertial measurement unit.

In an embodiment of the disclosure, the method further includes that historical work progress is stored corresponding to the historical waypoint, and in response to the head-mounted display reaching the historical waypoint, a virtual scene outputted by the head-mounted device is configured according to the historical work progress.

Based on the above, the head-mounted device of the disclosure can store the location of the user when completing the previous work as a historical waypoint. When the user returns to the field, the head-mounted device can superimpose the layout diagram of the field with the point cloud map to generate a superimposed map, and generate a virtual path in the superimposed map based on the sensing results obtained by the sensor to provide navigation services to the user through the virtual path.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 illustrates a schematic diagram of a head-mounted device for path planning according to an embodiment of the disclosure.

FIG. 2 illustrates a flowchart of executing path planning according to an embodiment of the disclosure.

FIG. 3 is a schematic diagram of generating a superimposed map according to an embodiment of the disclosure.

FIG. 4 illustrates a schematic diagram of generating a virtual path according to an embodiment of the disclosure.

FIG. 5 illustrates a flowchart of a method for path planning according to an embodiment of the disclosure.

### DESCRIPTION OF THE EMBODIMENTS

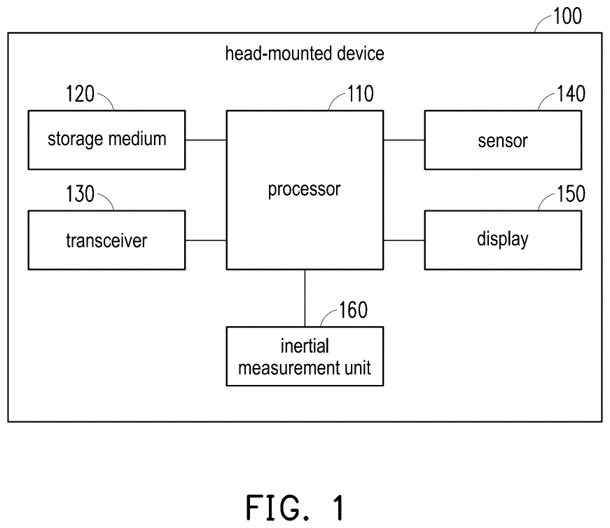

FIG. 1 illustrates a schematic diagram of a head-mounted device 100 for path planning according to an embodiment of the disclosure. The head-mounted device 100 may include a processor 110, a storage medium 120, a transceiver 130 and one or more sensors 140. In an embodiment, the head-mounted device 100 may further include a display 150 or an inertial measurement unit (IMU) 160. The head-mounted device 100 can be worn on the head of the user and can provide the user with an XR environment (or XR scene), such as a virtual reality (VR) environment, an augmented reality (AR) environment, or a mixed reality (MR) environment.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar components or a combination of the above components. The processor 110 can be coupled to the storage medium 120, the transceiver 130, the sensor 140, the display 150, and the IMU 160, and access and execute multiple modules and various applications stored in the storage medium 120.

The storage medium 120 is, for example, any type of fixed or removable random access memory (RAM), read-only memory (ROM), or flash memory, hard disk drive (HDD), solid state drive (SSD), or similar components or a combination of the above components, used to store multiple modules or various applications that can be executed by the processor 110. In this embodiment, the storage medium 120 may store information including a layout diagram of the field, a point cloud map of the field, or a historical waypoint corresponding to the field.

The transceiver 130 transmits or receives signals in a wireless or wired manner. The transceiver 130 may also perform operations such as low noise amplification, impedance matching, mixing, up or down frequency conversion, filtering, amplification, and similar operations.

The sensor 140 can be used to sense the environment around the head-mounted device 100 to generate a point cloud. The sensor 140 is, for example, a radar, a lidar, or an image capture device (such as a camera).

The display 150 may be used to display image data, such as providing an XR environment or XR scene for a user wearing the head-mounted device 100. The display 150 may include a liquid-crystal display (LCD) or an organic light-emitting diode (OLED) display. In one embodiment, the display 150 may provide an image beam to the eyes of the user to form an image on the retina of the user, so that the user can see the XR scene created by head-mounted device 100.

The IMU 160 can be used to measure acceleration to obtain the posture of the user wearing the head-mounted device 100. For example, the processor 110 may determine whether the user is tilting his or her head down or up based on the measurement results of the IMU 160.

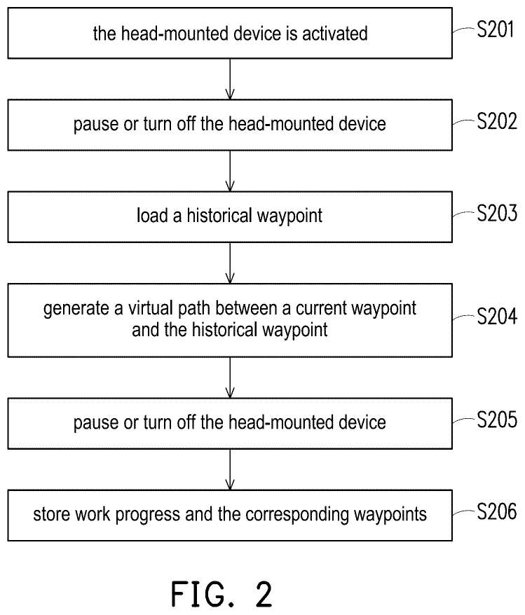

FIG. 2 illustrates a flowchart of executing path planning according to an embodiment of the disclosure, where the flowchart can be implemented by the head-mounted device 100 shown in FIG. 1. In step S201, the head-mounted device 100 may be activated.

In step S202, the head-mounted device 100 may perform relocalization. Specifically, the processor 110 can sense the environment around the head-mounted device 100 through the sensor 140 to obtain current point cloud. The current point cloud contains part of the environmental information in the field of the user. For example, if an obstacle appears in line of sight (LoS) of the sensor 140 or the user, the current point cloud may include one or more points corresponding to the obstacle.

In step S203, the processor 110 of the head-mounted device 100 may load a historical waypoint from the storage medium 120, where the historical waypoint corresponds to the field where the head-mounted device 100 or the user is located. The historical waypoint can be used on the layout diagram of the field or the point cloud map of the field to indicate where the user was when they completed the previous work. For example, if a maintenance crew of an aircraft finishes its work after checking the equipment near the wing and turns off the head-mounted device 100, the storage medium 120 can store a historical waypoint corresponding to the position near the wing.

In step S204, the processor 110 may generate a virtual path between the current waypoint and the historical waypoint, and output the virtual path to the user through an output device (e.g., the display 150 or a speaker coupled to the processor 110). The user can move in the field according to the virtual path outputted by the head-mounted display to reach the historical waypoint.

Specifically, the processor 110 can compare the characteristics of the current point cloud obtained by the sensor 140 with the characteristics of the point cloud map of the field, and then generate the current waypoint, where the current waypoint can be used to indicate the current location of the head-mounted device 100 or the user on the point cloud map.

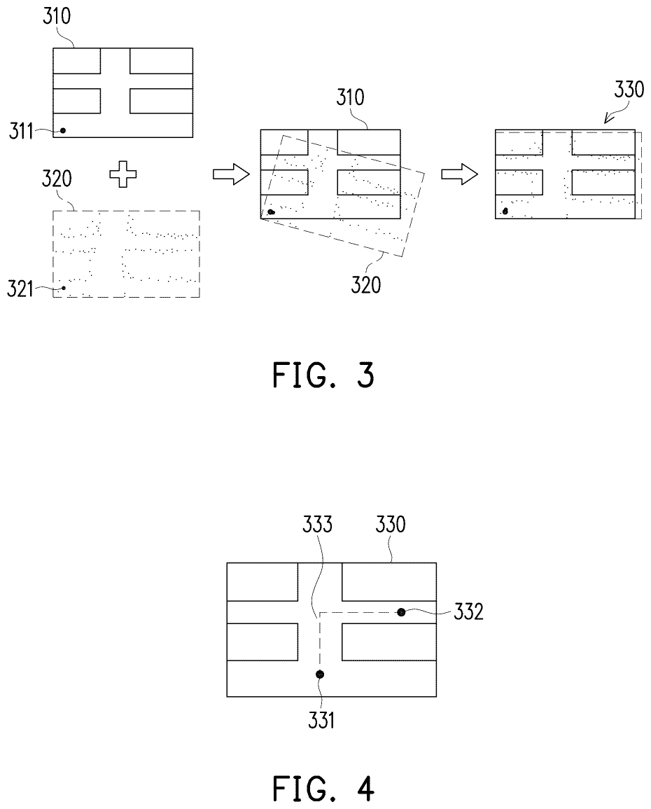

On the other hand, the processor 110 can obtain the reference point in the layout diagram of the field and the corresponding reference point in the point cloud map, and align the layout diagram and the point cloud map according to the two reference points, thereby generating a superimposed map. The layout diagram includes, for example, a computer aided design (CAD) diagram. FIG. 3 is a schematic diagram of generating a superimposed map 330 according to an embodiment of the disclosure. For example, the processor 110 can obtain a reference point 311 on a layout diagram 310 and a reference point 321 on a point cloud map 320 from the information input by the user, where the reference point 311 and the reference point 321 correspond to the same position. For example, the user can use the entrance of the field as a reference point, and mark the reference point 311 on the layout diagram 310 and the reference point 321 on the point cloud map 320 through instructions. In one embodiment, the road/wall border could be detected by edge detection algorithm according to the feature points in the point cloud map 320. The processor 110 can superimpose the layout diagram 310 and the point cloud map 320 according to the reference point 311 and the reference point 321 with the edges in the point cloud map 320 to generate a superimposed map 330. Any obstacles that appear in the layout diagram 310 or in the point cloud map 320 can be mapped to the superimposed map 330.

After obtaining the superimposed map 330, the processor 110 can generate a virtual path according to the superimposed map 330. Specifically, the processor 110 can mark the current waypoint and the historical waypoint on the superimposed map 330, and generate a virtual path between a previous waypoint and the historical waypoint according to the path planning algorithm. Taking FIG. 4 as an example, the processor 110 can mark the current waypoint 331 and the historical waypoint 332 on the superimposed map 330, and generate a virtual path 333 between the current waypoint 331 and the historical waypoint 332 according to the path planning algorithm. The path planning algorithm can include dynamic window approach.

The generation of the virtual path 333 takes into account the obstacles appearing in the layout diagram 310 and the obstacles appearing in the point cloud map 320. In one embodiment, when generating the virtual path 333, the processor 110 may further consider obstacles in the current point cloud. In other words, the generation of the virtual path 333 takes into account obstacles in the field detected at different points in time. In this way, when the head-mounted device 100 guides the user according to the virtual path 333, the probability of the user encountering obstacles may be greatly reduced.

After reaching the historical waypoint, the processor 110 can load historical work progress corresponding to the historical waypoint from the storage medium 120, and configure the virtual scene outputted by the head-mounted device 100 (e.g., displayed on the display 150) according to the historical work progress. For example, after the maintenance crew reaches the historical waypoint representing the location near the wing according to the guidance of the head-mounted device 100, the display 150 can display a virtual scene to indicate to the maintenance crew the equipment that the maintenance crew has repaired or to indicate that the maintenance crew has not yet repaired the equipment. In one embodiment, the virtual path 333 can be navigated by voice via earphone or vibration via a vibrator of head-mounted device 100. The invention is not limited thereto.

Returning to FIG. 2, after the user completes the work, in step S205, the user may input an instruction to the head-mounted device 100 to pause or turn off the head-mounted device 100. In step S206, the processor 110 may store the work progress of the user and the corresponding waypoints (i.e., the waypoints that represent the current location of the head-mounted device 100 or the user) as historical work records and historical waypoints in the storage medium 120 in response to the instructions entered by the user.

In one embodiment, the processor 110 can store the work records and the corresponding waypoint in the storage medium 120 according to the measurement results of the IMU 160. For example, when the measurement result of the IMU 160 indicates that the user assumes a particular posture (e.g., to maintain a head down for a period of time exceeding a threshold), the processor 110 may store the current work records and the corresponding waypoint in the storage medium 120 according to the measurement results. That is, the user can assume particular poses to record work progress and waypoints.

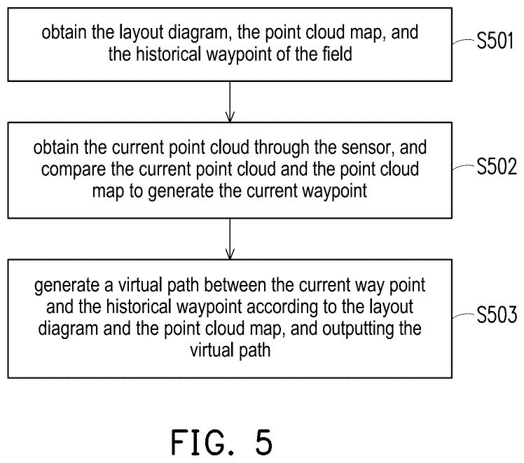

FIG. 5 illustrates a flowchart of a method for path planning according to an embodiment of the disclosure, where the method may be implemented by the head-mounted device 100 shown in FIG. 1. In step S501, the layout diagram, the point cloud map, and the historical waypoint of the field are obtained. In step S502, the current point cloud is obtained through the sensor, and the current point cloud and the point cloud map are compared to generate the current waypoint. In step S503, a virtual path between the current waypoint and the historical waypoint is generated according to the layout diagram and the point cloud map, and the virtual path is outputted.

To sum up, the head-mounted device of the disclosure can store the location of the user when completing the previous work as a historical waypoint. When the user returns to the field, the head-mounted device can superimpose the layout diagram of the field with the point cloud map to generate a superimposed map, and generate a virtual path in the superimposed map based on the sensing results obtained by the sensor. The head-mounted device can use the virtual path to guide the user to the historical waypoint. Since the superimposed map contains information such as the layout diagram and the point cloud map of the field, the head-mounted device can make the virtual path avoid obstacles located in the layout diagram or the point cloud map when generating the virtual path. In addition, the head-mounted device can automatically record the work progress of the user and the location of the user as the user performs specific actions. When the user returns to the location to complete the remaining work, the head-mounted device can show the work progress information to the user to facilitate the user to complete the work.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A head-mounted device for path planning, comprising:
a sensor;
a storage medium, storing a layout diagram, a point cloud map, and a historical waypoint of a field; and
a processor, coupled to the sensor, the display, and the storage medium, wherein
the processor obtains a current point cloud through the sensor, and compares the current point cloud with the point cloud map to generate a current waypoint, wherein
the processor generates a virtual path between the current waypoint and the historical waypoint according to the layout diagram and the point cloud map, and outputs the virtual path.

2. The head-mounted device according to claim 1, wherein
the processor generates the virtual path according to a first obstacle in the layout diagram and a second obstacle in the point cloud map.

3. The head-mounted device according to claim 2, wherein
the processor generates the virtual path according to a third obstacle in the current point cloud.

4. The head-mounted device according to claim 1, wherein
the processor obtains a first reference point corresponding to the layout diagram and a second reference point corresponding to the point cloud map, wherein
the processor aligns the layout diagram and the point cloud map according to the first reference point and the second reference point to generate a superimposed map, wherein
the processor generates the virtual path according to the superimposed map.

5. The head-mounted device according to claim 4, wherein the superimposed map indicates a first obstacle corresponding to the layout diagram and a second obstacle corresponding to the point cloud map.

6. The head-mounted device according to claim 4, wherein
the processor executes a path planning algorithm based on the superimposed map to generate the virtual path.

7. The head-mounted device according to claim 6, wherein the path planning algorithm comprises a dynamic window approach.

8. The head-mounted device according to claim 1, wherein the head-mounted device further comprises:
an inertial measurement unit, coupled to the processor, wherein
the processor stores work progress and a corresponding waypoint in the storage medium according to a measurement result of the inertial measurement unit.

9. The head-mounted device according to claim 1, wherein the storage medium further stores historical work progress corresponding to the historical waypoint, wherein
in response to the head-mounted device reaching the historical waypoint, the processor configures a virtual scene outputted by the head-mounted device according to the historical work progress.

10. The head-mounted device according to claim 1, wherein the sensor comprises at least one of the following: radar, lidar, and image capture device.

11. The head-mounted device according to claim 1, wherein the layout diagram comprises a computer aided design diagram.

12. A method for path planning, adapted to a head-mounted device, comprising:
obtaining a layout diagram, a point cloud map, and a historical waypoint of a field;
obtaining a current point cloud through a sensor, and comparing the current point cloud with the point cloud map to generate a current waypoint; and
generating a virtual path between the current waypoint and the historical waypoint according to the layout diagram and the point cloud map, and outputting the virtual path.

13. The method according to claim 12, wherein generating the virtual path between the current waypoint and the historical waypoint according to the layout diagram and the point cloud map comprises:
generating the virtual path according to a first obstacle in the layout diagram and a second obstacle in the point cloud map.

14. The method according to claim 13, wherein generating the virtual path according to the first obstacle in the layout diagram and the second obstacle in the point cloud map comprises:
generating the virtual path according to a third obstacle in the current point cloud.

15. The method according to claim 12, wherein generating the virtual path between the current waypoint and the historical waypoint according to the layout diagram and the point cloud map comprises:
obtaining a first reference point corresponding to the layout diagram and a second reference point corresponding to the point cloud map;
aligning the layout diagram and the point cloud map according to the first reference point and the second reference point to generate a superimposed map; and
generating the virtual path according to the superimposed map.

16. The method according to claim 15, wherein the superimposed map indicates a first obstacle corresponding to the layout diagram and a second obstacle corresponding to the point cloud map.

17. The method according to claim 15, wherein generating the virtual path according to the superimposed map comprises:
executing a path planning algorithm according to the superimposed map to generate the virtual path.

18. The method according to claim 17, wherein the path planning algorithm comprises a dynamic window approach.

19. The method according to claim 12 further comprising:
storing work progress and a corresponding waypoint according to a measurement result of the inertial measurement unit.

20. The method according to claim 12 further comprising:
storing historical work progress corresponding to the historical waypoint; and
in response to the head-mounted device reaching the historical waypoint, configuring a virtual scene outputted by the head-mounted device according to the historical work progress.
